(19) United States
(12) Patent Application Publication
(10) Pub. No.: US 2005/0246096 A1
(43) Pub. Date: Nov. 3, 2005

(54) Advance road viewing for passing process

(76) Inventors: Alexander Bracht, Esslingen (DE); Dirk Mehren, Sindelfingen (DE); Daniel Buck, Blaubeuren (DE)

Correspondence Address: PENDORF & CUTLIFF, 5111 MEMORIAL HIGHWAY, TAMPA, FL, 33634-7356, US

(21) Appl. No.: 11/118,988

(22) Filed: Apr. 29, 2005

(30) Foreign Application Priority Data
Apr. 29, 2004 (DE) 10 2004 021 278.3
Jul. 6, 2004 (DE) 10 2004 027 695.1

(51) Int. Cl. G01C 21/30

(52) U.S. Cl. 701/211

(57) ABSTRACT

The invention concerns a system for informing the driver regarding sections of road lying ahead and being considered for a passing process. For this, the system employs, on the basis of known navigation systems, special data from digital maps in order to carry out an evaluation of ahead lying sections of road according to various criteria. Vehicle specific data, driver profiles or data regarding the actual weather situation can be incorporated into the evaluation. As a result, ahead lying stretches of road are classified as to their suitability for a passing maneuver, and the driver is informed, for example, by a display.

### BACKGROUND OF THE INVENTION

1. Field of the Invention

The invention concerns vehicle on-board devices for providing information to the operator of the vehicle, for example, regarding the driving route and the actual position of the vehicle. This type of system is already used for providing navigation guidance, using GPS to continuously determine position and using maps in memory to provide the driver with information regarding road network navigation guidance for the ahead-lying road, for example, optically using a display or acoustically by spoken output. This system offers a good guidance to a goal, which represents a substantial reduction in workload when driving to an unknown city or when driving in conditions of limited visibility.

2. Related Art of the Invention

An improved system for providing information for route guidance is described in EP0773525B1 (U.S. Pat. No. 6,035,253). The technique taught in this document uses conventional GPS-navigation system street maps supplemented with contour informatoion in order to determine therefrom the breadth of the roads actually being driven. As a result, the driver is provided with the road breadth and possibly also the number of available lanes.

Passing maneuvers are critical situations, particularly in traffic, and require a high level of concentration from the vehicle operator. The estimation of the possibility of a good passing maneuver can be complicated for the driver by additional factors such as adverse visibility conditions (darkness, rain). The supporting of the driver by an automatic on-board preview of the route, including an evaluation of the road regarding possible passing maneuvers and the reporting thereof, for example by incorporation into displays in the dashboard, would thus be very useful.

The present invention begins with a system as disclosed in EP0773525B1 as the closest state of the art. The present invention is concerned with a task of developing a system for informing vehicle operators, which can offer the driver with a continuously updated description of the route lying ahead, so that the vehicle operator is able on the basis of this information to better pre-plan in particular passing maneuvers.

### SUMMARY OF THE INVENTION

This task is solved by the system according to claim 1. Further advantageous embodiments of the inventive system are the subject of the dependent claims. The invention is described in the following on the basis of a preferred embodiment.

The information systems known until now are primarily conceived as navigation aides and thus provide only partial aspects of the route lying ahead. For the driver who would like to pass a vehicle ahead of him, it is however of particular interest to obtain information regarding the section of road lying immediately ahead, which could serve as a basis for a decision as to whether to possibly undertake a passing maneuver. In particular, when driving on roads which are partially single lane (for example highways), passing maneuvers are particularly critical, since here passing can occur only when using the oncoming traffic lane.

Required information thus concerns, in a first aspect, the overview of the section of road lying ahead, that is, for example, whether a sufficiently long section of the oncoming traffic lane is available. Besides this, for passing maneuvers, additional indications regarding the character or quality of the ahead lying section are of consequence, including the classification of the road to be used, as well as the number of available lanes or the breadth of the lanes.

The inventive system includes as the base unit a conventional navigation system with position determination using, for example, GPS. The road maps employed today in this type of system, for example stored digitally on CD, already contain among other things various indications which make possible an initial estimation for predicting the route lying ahead. These include, for example, stored information regarding the course of the road (curves, bends) or also indications regarding road breadth or number of lanes, as well as tunnels, crossings, etc. The system according to the invention employs in particular these available data and relays, with appropriate designed data-processing devices, from the actual vehicle position and direction of driving, a preview of the road with the aspect of suitability for possible passing maneuvers. For this there occurs preferably a classification, depending upon whether the stretch of road lying ahead is suited or not suited for a passing process. Values concerning traffic experience can be pre-input for this as evaluation criteria. For example, curved stretches are primarily unsuited; likewise, single lane and narrow roads, as well as sections with tunnels, crossings or branches are unsuited. In the case of gentle direction changes of the course of the road, the overview of the ahead lying stretch of road depends upon the radius of the curvature. Longer road sections without curves, broad or multi-lane roads, in contrast, offer basically good possibilities of passing.

In a further embodiment the inventive system provides detailed digital road maps in which—in comparison to the data contained in conventional navigation systems regarding the road network—supplemental information is stored. This supplemental information preferably includes indications regarding the road itself such as, for example, overview, height profile, visibility, markings, road quality (new surface, etc.) or even locally relevant traffic regulations (no passing zone, speed restrictions, etc.). With this supplemental information, ahead lying sections of road can be evaluated substantially more precisely. For example, a section with curves (primarily unsuited) can nevertheless be considered for a passing maneuver if a good overview is available (flat route on a plane, no impediments to view). Also, indications regarding height profile are of particular consequence, since a straight section of road (generally evaluated as suitable for a passing maneuver) which passes over a knoll would, however, be unsuitable for a passing maneuver on the basis of the restricted range of view (unless however the road is multi-lane). By restrictive traffic regulations (for example no passing zone) even those sections of road identified as suitable for a passing maneuver cannot be used. These varying aspects are combined with each other for a total evaluation and make possible with increased quality a one step evaluation of sections of road lying ahead regarding suitability for a passing maneuver.

For a further detailed classification the inventive system can be preferably so further developed that, in addition to map information, it also takes into consideration supplemental perimeters. For example, the time needed for a passing maneuver (and therewith the length of the segment of road needed for passing) depends directly upon the actual speed of the vehicle. In addition, the rate of acceleration (motor output, vehicle weight) plays a substantial role, in order for example to quickly carry out a passing process and therewith to shorten the critical passing phase as much as possible. These data are available for digital processing in modern vehicles, and can be included in the road evaluation.

In a further embodiment the inventive system takes into consideration available information regarding the actual weather or, as the case may be, atmospheric conditions. Fog, strong rain, snow, and onset of frost can strongly restrict the suitability for passing maneuvers. Also, the location of the sun (in certain cases blinding by low lying sun) or the light intensity (day, night, dawn, twilight, full moon, oncoming light, blindness due to artificial light) have influence on the evaluation of the driving situation with respect to a possible passing maneuver. Further information regarding the condition of the road (for example ice, leaves, concrete, tar, crushed rocks), or, as the case may be, regarding the appearance of traffic, in particular regarding the lane necessary for passing, preferably the oncoming lane, have proven to be particularly relevant for taking into consideration alone or together with other evaluation criteria. For example, in the case of heavy oncoming traffic a passing process is less recommended than in the case of light oncoming traffic, and the driver is accordingly informed. Information regarding the weather or, as the case may be, atmospheric conditions, or also the traffic conditions or the road conditions, are communicated wirelessly for example by traffic information centers to the navigation device or other assist systems. Besides this, modern vehicles are equipped with sensors which provide appropriate data.

In a further embodiment the inventive system takes into consideration available information regarding the preceding vehicles, in particular with respect to the speed differential and/or the spacing of these from each other and/or from the own vehicle. This information can be determined by vehicle sensors, for example radar, and can be supplied for a determination with respect to recommending passing or not, and subsequently the vehicle operator can be accordingly informed. In particular the acceleration characteristic of a vehicle to be potentially passed is compared with that of the own vehicle, and there results of this comparison is provided to the driver. If the differential is too small, then a warning is issued regarding the passing process.

In a further embodiment the inventive system takes into consideration available information regarding the route planned by means of the route guidance, for example in the form of a navigation device, wherein in particular the distance to the next planned change of route is utilized as one of the evaluation criteria. If a turning off from the present street is to be undertaken shortly on the basis of the planned route (small distance to the location of the planned route change), then this criteria is taken into consideration and the driver is accordingly informed, for example by a recommendation against a passing process.

In a further embodiment of the inventive system the characteristic driving behavior of a driver is taken into consideration. For this, means are provided in the vehicle which, during driving, detect aspects of the driving style of the individual and stores this as a set of data. A more aggressive driver employs, for example, the motor power during the acceleration processes in a different manner than a more conservative driver. In this manner a profile can be established for each user of the vehicle. If the same driver later utilizes the vehicle, then by comparison operations the characteristic profile can be recognized and called up from memory. Since passing processes are in large part a function of driving style, this type of profile is of substantial significance for the evaluation of the ahead lying stretch of road regarding suitability for a passing maneuver.

The driver is presented with the forecast of the road lying ahead, for example in the form of a graphic representation on a display. Depending upon the suitability of the road lying ahead for a passing maneuver, appropriate indications can be called up therein by text, symbols, coloration or blinking effects. Likewise, acoustic indications can occur, for example by a speech generator. Also, other indications regarding the ahead lying stretch of road can be presented in this manner. Thus a driver can be advised for example the distance to the next potential passing section, of which the dimensions indicate a suitable passing area, or also whether the passing area or passing section is long enough for a passing process, taking into consideration the present vehicle speed and acceleration reserve. Further, a recommendation not to pass can be part of the information provided to the driver. Also, an indication of affirmative pre-conditions for passing, to the extent that this could be determined on the basis of available information, can be brought to the attention of the driver. In a particularly preferred embodiment of the invention, in addition the low beam or high beam of the vehicle is switched on, so that the vehicle with the system is more recognizable, whereby the risk for an accident can be further reduced. Following a passing process the light can again be switched off.

The information made available by the inventive system can either be obtained online by the system or, as the case may be, can be activated or triggered situation-dependent as pre-formulated information (event-concept). Therein the pre-formulated information (advice or suggestions to the driver) are preferably stored in an updateable or overwritable storage medium or memory.

The information provided by the inventive system is of substantial importance for the intended passing maneuver, in particular with regard to traffic safety. By appropriate preparation and presentation the suggestions or advice are easy for the drive to understand while driving, and easy to integrate in his driving behavior.

1-12. (canceled)

13. A system for providing in a road vehicle a preview with regard to suitability for a passing processes for ahead-lying sections of road, comprising:
means for detecting the position and direction of travel for the vehicle,
means for storing a digital road map,
means for evaluating the digital road map depending upon the position and direction of travel of the vehicle, and
means for output of information,
wherein the means for evaluating
extract from the digital road map special items of information concerning the section of road lying ahead, which items of information are predetermined in the system as being relevant to overtaking maneuvers,
processes this information on the basis of predetermined judgment criteria, and
presents the thus processed information to the driver via the means for output.

14. The system according to claim 13, wherein the extracted information includes features of the section of road lying ahead.

15. The system according to claim 14, wherein said features include one or more of the class of road, breadth of road, marking, number of lanes available in each direction of driving, presence of tunnels, crossings, and branches.

16. The system according to claim 13, wherein the extracted information includes indications regarding the topography of the road lying ahead

17. The system as in claim 16, wherein said topography includes straight road segments, gentle changes in direction, number and radius of curves, ability to overview, as well as rise and fall of the road.

18. The system according to claim 13, wherein the extracted information includes information regarding traffic regulations applicable for the section of road lying ahead

19. The system according to claim 18, wherein said traffic regulations include speed limits and no-passing zones.

20. The system according to claim 13, wherein vehicle characteristics (type, weight, acceleration values, etc.) are provided as evaluation criteria.

21. The system according to claim 13, wherein means are provided for recognizing the actual weather situation (for example sensors, in certain cases means for receiving wireless transmitted weather data), the condition of the road and/or the appearance of traffic, in particular regarding the passing lane, and these data concerning the weather situation, the road condition and/or the appearance of traffic are predetermined to be evaluation criteria.

22. The system according to claim 13, wherein means are provided for detecting the driving behavior of preceding traffic, in particular with respect to the differential in speed and/or distance, and wherein these data concerning driving characteristics are predetermined to be evaluation criteria.

23. The system according to claim 13, wherein a means is provided for route guidance, and wherein the route data, in particular the distance to the next planned change in route, is predetermined to be one of the evaluation criteria.

24. The system according to claim 13, wherein means are provided for detecting and storing or recording driver profiles, and wherein these data are predetermined to be evaluation criteria.

25. The system according to claim 13, wherein sections of road lying ahead are classified depending upon the extracted information and evaluation criteria.

26. The system according to claim 25, wherein prepared information regarding variously classified ahead lying sections of road are presented in varying manner to the driver via the means for output (for example, optically by varying symbols, coloration, blinking, etc., acoustically via various signal tones, etc.).

27. The system according to claim 13, wherein means are provided for controlling the driving headlight or high beam, and wherein depending upon the collected information, the driving headlight or high beam is switched on or off.
